(19) United States
(12) Patent Application Publication
(10) Pub. No.: US 2013/0212924 A1
(43) Pub. Date: Aug. 22, 2013

(54) DECOY STANDS AND FLOATING DECOY SYSTEMS

(71) Applicant: Stephen M. Shisko, Charleston, SC (US)

(72) Inventor: Stephen M. Shisko, Charleston, SC (US)

(21) Appl. No.: 13/398,424

(22) Filed: Feb. 16, 2012

(51) Int. Cl. A01M 31/06; B63B 43/06; F16M 11/00

(52) U.S. Cl. 43/2; 248/176.1; 114/121

(57) ABSTRACT

A decoy stand and a floating decoy system configured to stabilize at least one decoy above the surface of water, in one aspect, has a coupling; a first arm connected to the coupling at or near one end and extending outwardly from the coupling and having a distal end to which a decoy may be attached or connected; and a plurality of second arms, with each second arm connected to the coupling and extending outwardly from the coupling at an angle to the first arm, said second arms having distal ends to which a decoy may be attached or connected.

### BACKGROUND

The field of the present invention relates to decoy stands and floating decoy systems used in attracting animals, such as waterfowl.

In attracting animals, such as waterfowl, a person often sets up decoys to attract waterfowl to come within a desired range of the person. When attracting waterfowl such as, for example, ducks, decoys imitating live ducks are often placed in the water. Furthermore, certain types of decoys are designed to look as if the waterfowl is in the process of landing on or taking off from the water. For example, Mojo Outdoors® produces a waterfowl decoy having rotating wings that are controlled with a remote control. In addition, other types of decoys incorporate various types of motion mechanisms to aid in attracting an animal. In such decoys, it is often desired to elevate the decoy above the water. The decoy stands provided with, for example, Mojo Outdoors® products, include a buoyant disk with a vertical extending pole that attaches to a decoy to elevate the decoy above the water.

However, such buoyant disks and pole assembly do not provide the necessary stability in rougher conditions or in situations where the decoy is to be placed in moving water. Moreover, decoys that have moving parts can also lead to tipping or destabilization of the decoy stand when the movements generate a sufficient amount of inertia. For example, such decoys often tip over or exhibit unnatural motion which may deter instead of attract an animal. Moreover, the stands do not provide any ability to connect more than one decoy. Furthermore, such decoy stands are visible above the water's surface, which may decrease the effectiveness of the decoy to attract animals.

Therefore, a need exists to provide decoy stands and floating decoy systems that have increased stability in rough and/or moving water. Further, a need exists to provide decoy stands and floating decoy systems that can hold one or more decoys above the water, while hiding a substantial portion of the decoy stand below the surface of the water. Still further, a need exists to provide decoy stands and floating decoy systems that provide the ability to connect more than one decoy to the decoy stand or floating decoy system.

### SUMMARY OF THE DISCLOSURE

Embodiments disclosed herein relate to a decoy stand and a floating decoy system configured to stabilize at least one decoy above the surface of water.

In one aspect, the decoy stand comprises: a coupling; a first arm connected to the coupling at or near one end and extending outwardly from the coupling and having a distal end to which a decoy may be attached or connected; and a plurality of second arms, with each second arm connected to the coupling and extending outwardly from the coupling at an angle to the first arm, said second arms having distal ends to which a decoy may be attached or connected.

Another aspect includes a decoy stand comprising: a coupling; a first arm; and a plurality of second arms; wherein said coupling is adapted to releasably connect the first arm and the plurality of second arms; wherein said plurality of second arms is disposed essentially perpendicular to the first arm; wherein each of said plurality of second arms and said first arm are adapted to releasably connect to a decoy; and wherein at least some of said plurality of second arms define one or more apertures configured to allow water to flow within the plurality of second arms.

Another embodiment relates to a floating decoy system configured to stabilize at least one decoy above the surface of water. In one aspect, the floating decoy system comprises: a first decoy; a plurality of second decoys; and a decoy stand comprising: a center; a first arm configured for connection with the center and extending outwardly from the center, wherein said first arm is configured for connection to the first decoy; and a plurality of second arms configured for connection with the center and extending outwardly from the center at an angle to the first arm, wherein the plurality of second arms are configured for releasable connection to at least one of the plurality of second decoys.

### BRIEF DESCRIPTION OF THE DRAWINGS

The foregoing summary, as well as the following detailed description of the invention, may be better understood when read in conjunction with the appended drawings. For the purpose of assisting in the explanation of the invention, there are shown in the drawings representative embodiments which are considered illustrative. It should be understood, however, that the invention is not limited in any manner to the precise arrangements and instrumentalities shown.

In the drawings:

FIG. 1 illustrates a perspective view of a decoy stand according to an embodiment of the present invention.

FIG. 2 illustrates a bottom view of a coupling according to an embodiment of the present invention.

FIG. 3 illustrates a perspective view of a floating decoy system according to an embodiment of the present invention.

FIG. 4 illustrates a front view of a floating decoy system according to an embodiment of the present invention.

FIG. 5 illustrates an exploded view of a decoy stand according to an embodiment of the present invention.

### DETAILED DESCRIPTION OF THE DISCLOSURE

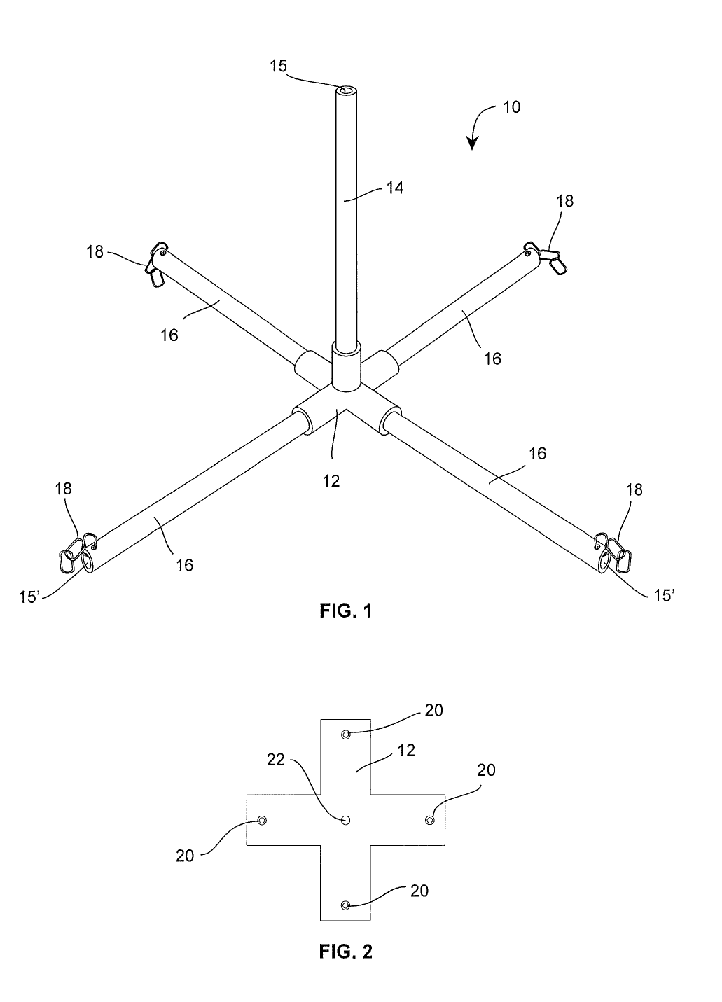

Referring now to FIG. 1, there is illustrated a decoy stand according to an embodiment of the present invention. The decoy stand 10 includes a coupling 12 (i.e. center). A first arm 14 connects to the coupling at is proximal end and extends essentially vertically from the coupling 12. Although the decoy stand 10 is illustrated and described as having a single first arm, it is to be understood that more than one first arm can be employed. The decoy stand 10 further includes a plurality of second arms 16 connected at their proximal end to the coupling 12 and extending horizontally outward from the coupling 12. The first arm 14 and the plurality of second arms 16 can be made of any material, and can be made from the same or different materials. In certain embodiments, the first arm 14 and the plurality of second arms 16 may be made of PVC pipe, other plastic, metal, wood or a combination thereof. Furthermore, in certain embodiments, the first arm 14, the plurality of second arms 16, and/or the coupling 12 may be made of material that has a density greater than water. In certain other embodiments, the first arm 14, the plurality of second arms 16 and/or the coupling 12 may be made of a material that has a density less than water.

The plurality of second arms 16 may include four arms, where each arm may releasably connect to the coupling. In other embodiments, the plurality of second arms may include two arms, where the arms extend through the coupling so that both ends of an arm are about equal distances from the coupling. In certain embodiments, the distance of the ends of the plurality of second arms 16 to the coupling 12 may be adjustable and the overall length of the arms may be adjustable. For example, in certain embodiments, the first arm 14 and/or the plurality of second arms 16 may telescope out from the coupling 12.

Referring again to FIG. 1, the decoy stand may further include a plurality of connectors 18 disposed on the distal ends of the plurality of second arms 16, which are configured for connection with a plurality of decoys, preferably buoyant decoys. For example, the plurality of connectors 18 may be a chain and clip assembly.

Furthermore, the distal end of the first arm 14 may be adapted to connect the first arm 14 to a first decoy. For example, the first arm 14 may include an aperture 15 so that the first arm is at least partly hollow. As illustrated in FIG. 3, a first decoy 32 may further include an arm or pole that can be inserted into the aperture 15 or hollow portion of the first arm 14. It is to be understood that the first arm 14 and/or the plurality of second arms 16 may be connected to a respective decoy by any design or mechanism that allows a connection from the arms to the decoys.

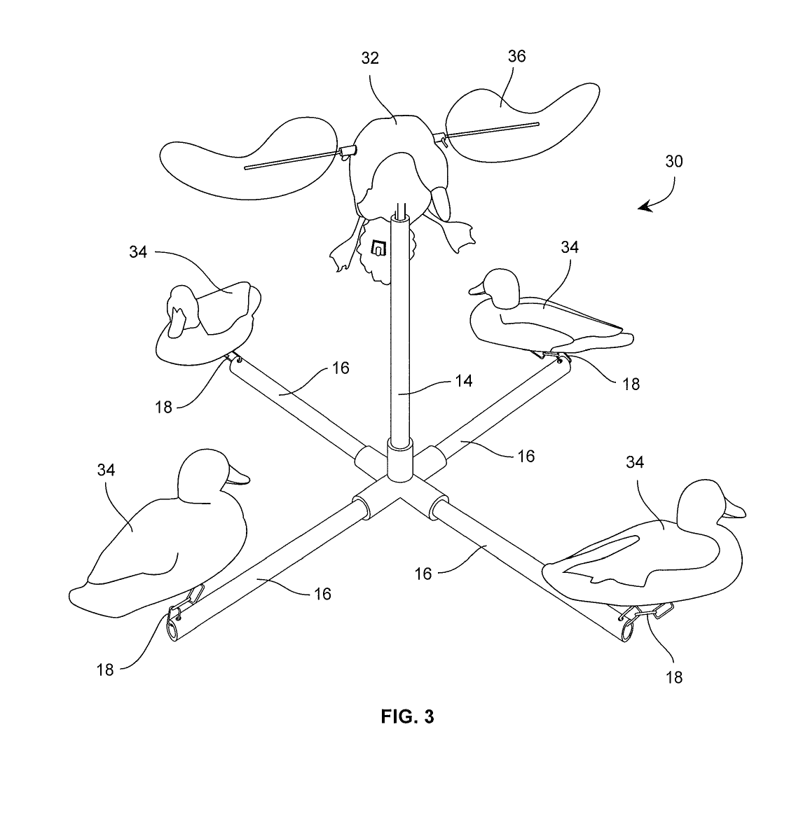

Referring now to FIG. 2, there is illustrated a bottom view of the coupling 12 illustrated in FIG. 1. The coupling 12 may include a plurality of apertures 20 configured to receive a portion of the plurality of second arms 16 so that the second arms 16 may be securely and releasably coupled to the coupling 12. For example, the plurality of second arms 16 may include a spring action button (not shown), or the like, that can pop through the aperture 20 thereby coupling the second arm to the coupling. In certain embodiments, each of the plurality of apertures 20 may be tapered to assist in receiving a proximal portion of the second arm. It is to be understood that the first arm 14 and/or the plurality of second arms 16 may be connected to the coupling 12 by any design or mechanism that allows a connection from the arms 14,16 to the coupling 12.

The coupling 12 may further include a center aperture 22 which is configured to receive a loop and an anchor assembly 23 or the like. The loop and anchor assembly 23 may be attached or connected to the decoy stand 10 through the aperture 22 to provide further stability to the decoy stand and to anchor the decoy stand 10 in place in moving water. The loop and anchor may further serve to keep the decoy stand 10 in place during windy conditions.

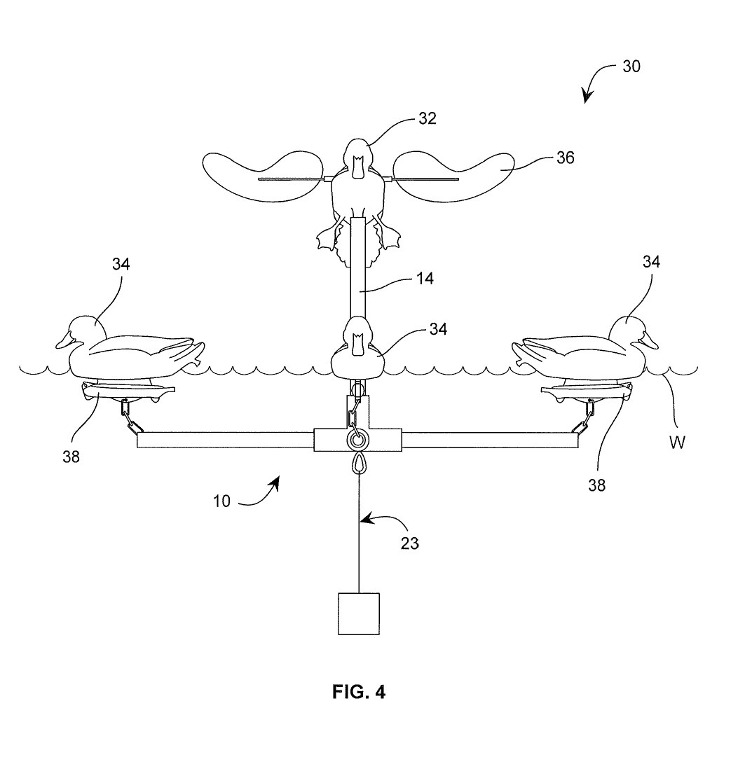

Referring now to FIGS. 3-4, there is shown a floating decoy system 30 according to another aspect of the present invention. The decoy system 30 includes the decoy stand 10 of FIG. 1 and further includes a first decoy 32 coupled to the first arm 14 and a plurality of second decoys 34 coupled to the plurality of second arms 16. As illustrated in FIG. 4, when the floating decoy system 30 is placed in the water, the decoy stand 10 submerses below the surface of the water W, except for at least a portion of the first arm 14, which extends above the surface of the water W. The decoy stand 10 is prevented from sinking due to the connection with the plurality of buoyant second decoys 34. Furthermore, an equidistant spacing of the plurality of second decoys 34 can assist in providing an essentially vertical positioning of the first arm 14 and thus the first decoy 32. It is to be understood that the exact placement of and configuration of the second decoys 34 and the length and number of the second arms 16 may be adjusted to provide a desired orientation of the first arm 14, relative to the surface of the water W as well as a desired level of stability.

In certain embodiments, the first decoy 32 may have movable pieces and/or be rotatable about the first arm 14. For example, as particularly illustrated in FIG. 3-4, the first decoy 32 may have rotatable wings 36 that simulate an animal's motion. In particular embodiments, the first decoy 32 may be configured to simulate a waterfowl landing on or taking off from the surface of the water. For example, the first decoy 32 may be a decoy such as a BABY MOJO® decoy from MOJO Outdoors®, Monroe, La. However, it is to be understood that the first decoy is not limited to a particular type of movement capability.

Each of the plurality of second decoys 34 may be any decoy that is buoyant. As illustrated in FIG. 4, each of the plurality of second decoys 34 may further comprise a stabilizer 38 to stabilize the second decoy in an upright position.

Referring to FIGS. 1-4, in certain embodiments, the first arm 14, the plurality of second arms 16 and/or the coupling 12 may include an aperture 15, 15′, i.e. be at least partly hollow, so that when the decoy stand 10 is placed in water, the water is allowed to flow within at least a portion of the interior of the decoy stand 10. The water serves to provide weight and ballast to the decoy stand 10 so that all but the first arm 14 or a portion of the first arm 14 can be held underneath the surface of the water W. In this way, the decoy stand 10 may be ballasted below the surface of the water W and provide stability to the decoy stand. The substantial increase in stability allows the decoy stand to be placed in moving and/or rough water so that a first decoy 34 connected to the first arm 14 would be stabilized against flipping or touching the water surface, even when hit by waves. Moreover, when the first decoy 32 contains movable parts, the ballasting of the decoy stand 10 may assist in providing further stability to the first decoy 32 while the first decoy 32 is in motion. Another particular advantage of having a substantial part of the decoy stand 10 below the surface of the water W is that animals to be attracted by the decoy(s) cannot see the decoy stand. Furthermore, it is to be understood that the configuration and number of the second arms 16 can be selected to help provide a desired level of stability. For example, in certain conditions, a longer length of the plurality of second arms 16 can increase stability of the decoy stand 10. Furthermore, having a larger number of the second arms 16 and second decoys 34 can increase the stability of the decoy stand 10 in certain conditions. Moreover, having the plurality of second arms 16 being rigid may further increase the stability of the decoy stand 10. Still further, it is to be understood that although the decoy stand 10 has been described in separate connectable pieces, it is contemplated, in certain embodiments, to have the decoy stand 10 be a unitary piece.

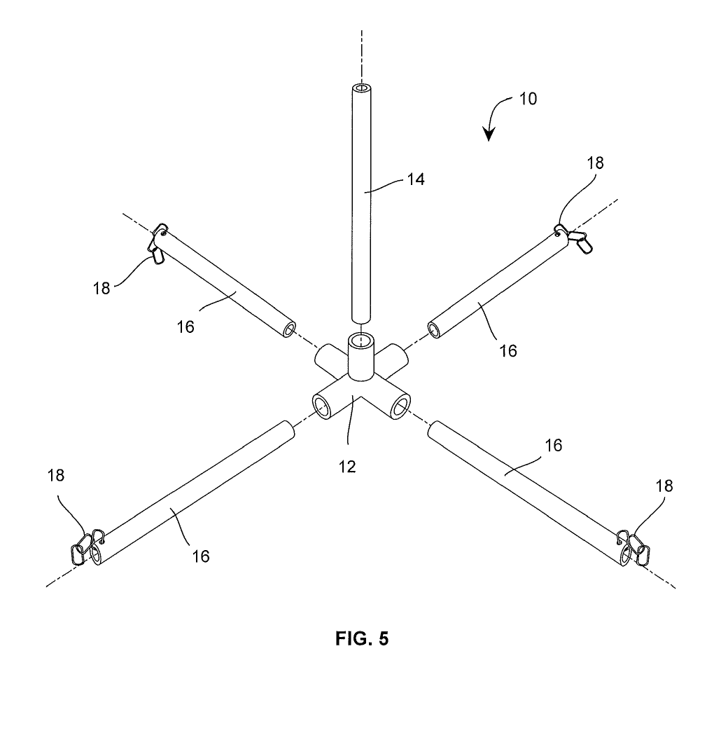

Referring now to FIG. 5, there is illustrated an exploded view of the decoy stand illustrated in FIG. 1. Another particular advantage of certain embodiments of the decoy stand 10 illustrated in FIG. 5 occurs when the first arm 14 and the plurality of second arms 16 are configured for releasable connection with the coupling 12. By being releasably connected, such as for example, with a spring action button and an aperture (not shown), the volume of the disassembled stand can be greatly decreased in comparison to the volume of the assembled stand so that transportation and packaging of the stand can be made more efficient.

Although the present invention has been described with reference to the embodiments set forth, those skilled in the art will recognize that changes may be made in form and detail without departing from the spirit and scope of the invention. For instance, the decoy stand may be used to attract a variety of animals. Likewise, the decoy stand may include any number of configurations of arms and decoys in a desired situation.

What is claimed:

1. A decoy stand, comprising:
a coupling;
a first arm connected to the coupling at or near one end and extending outwardly from the coupling and having a distal end to which a decoy may be attached or connected; and
a plurality of second arms, with each second arm connected to the coupling and extending outwardly from the coupling at an angle to the first arm, said second arms having distal ends to which a decoy may be attached or connected.

2. The decoy stand of claim 1, wherein the first arm and/or the plurality of second arms extend a distance from the coupling, and wherein the distance from the coupling is adjustable.

3. The decoy stand of claim 1, wherein each of the plurality of arms extends about the same distance from the coupling.

4. The decoy stand of claim 1 further comprising a loop connected to the coupling and extending vertically outwardly from the coupling in the opposite direction of the first arm.

5. The decoy stand of claim 4 further comprising an anchor connected to the loop.

6. The decoy stand of claim 1, wherein said plurality of second arms define one or more apertures to receive water to ballast the decoy stand.

7. The decoy stand of claim 1, wherein said coupling defines one or more apertures to receive water.

8. The decoy stand of claim 1, wherein the first arm extends essentially vertically outwardly from the coupling and the plurality of second arms extends at about a 90° angle from the first arm.

9. A decoy stand comprising:
a coupling;
a first arm; and
a plurality of second arms;
wherein said coupling is adapted to releasably connect the first arm and the plurality of second arms;
wherein said plurality of second arms is disposed essentially perpendicular to the first arm;
wherein each of said plurality of second arms and said first arm are adapted to releasably connect to a decoy; and
wherein at least some of said plurality of second arms define one or more apertures configured to allow water to flow within the plurality of second arms.

10. A floating decoy system comprising:
a first decoy;
a plurality of second decoys; and
a decoy stand comprising:
a center;
a first arm configured for connection with the center and extending outwardly from the center, wherein said first arm is configured for connection to the first decoy; and
a plurality of second arms configured for connection with the center and extending outwardly from the center at an angle to the first arm, wherein the plurality of second arms are configured for releasable connection to at least one of the plurality of second decoys.

11. The system of claim 10, wherein said first decoy comprises movable wings.

12. The system of claim 10, wherein said plurality of second decoys are buoyant.

13. The system of claim 10, wherein the first arm and/or the plurality of second arms extend a distance from the coupling, and wherein the distance from the coupling is adjustable.

14. The system of claim 10, wherein each of the plurality of arms extends about the same distance from the coupling.

15. The system of claim 10 further comprising a loop connected to the coupling and extending vertically outwardly from the coupling in the opposite direction of the first arm and an anchor connected to the loop.

16. The system of claim 10, wherein the first arm extends essentially vertically outwardly from the coupling and the plurality of second arms extends at about a 90° angle from the first arm.

17. The system of claim 10, wherein at least a portion of the decoy stand comprises one or more apertures configured to receive water to ballast the decoy stand.

18. The system of claim 10, wherein the plurality of second arms and/or the coupling comprise an aperture configured to receive water to ballast the decoy stand and keep all of the decoy stand, except for at least a portion of the first arm, underneath the surface of water.

19. The system of claim 10, wherein the decoy stand is at least partly stabilized underwater by at least the plurality of second decoys.

20. The system of claim 10, wherein at least one of the plurality of second decoys further comprise a stabilizer.
